(19) United States
(12) Patent Application Publication
(10) Pub. No.: US 2007/0095890 A1
(43) Pub. Date: May 3, 2007

(54) System and method for providing consolidated fuel pricing information

(76) Inventor: Steven Mark Elefant, Lafayette, CA (US)

Correspondence Address: Steven Elefant, 4033 Tilden Lane, Lafayette, CA, 94549, US

(21) Appl. No.: 11/580,657

(22) Filed: Oct. 14, 2006

Related U.S. Application Data
(60) Provisional application No. 60/733,054, filed on Nov. 2, 2005.

(51) Int. Cl. G06K 15/00

(52) U.S. Cl. 235/378; 705/400

(57) ABSTRACT

Steven Elefant claims priority to provisional patent application No. 60/733,054, dated Nov. 2, 2005, and titled “System and Method for Providing Consolidated Fuel Pricing Information.” Aircraftfuel.com is a service to assist pilots, owners and flight departments compare fuel pricing from multiple discount and regular fuel providers and see them presented as a single source. The system quickly and efficiently provides consolidated pricing information, by destination or flight route, from a plurality of sources on a nearly real-time basis. The user inputs their unique information, per fuel provider (if needed), to access their specific pricing at each destination or along a route of flight

### SUMMARY

Steven Elefant claims priority to provisional patent application No. 60/733,054, dated Nov. 2, 2005, and titled “System and Method for Providing Consolidated Fuel Pricing Information.” Aircraftfuel.com is a service to assist pilots, owners and flight departments compare fuel pricing from multiple discount and regular fuel providers and see them presented as a single source. The system quickly and efficiently provides consolidated pricing information, by destination or flight route, from a plurality of sources on a nearly real-time basis. The user inputs their unique information, per fuel provider (if needed), to access their specific pricing at each destination or along a route of flight.

### BACKGROUND OF THE INVENTION

Conventionally, companies may utilize company owned or corporate jets in order to control travel costs and provide convenience to their employees: This added convenience allows for increased employee productivity. Privately owned jets also provide their owners with the same benefits.

The costs to maintain and operate these jets, however, are increasingly expensive. For example, the cost of fuel is unpredictable and can vary immensely between locations. Often, the fuel costs account for half of the cost for flying the jet.

Because pilots or flight planning departments can determine where to refuel and plan their flight routes accordingly, it may be advantageous to drop off passengers at their destination, but refuel at a nearby airport offering lower fuel prices. Additionally, companies and individuals may have memberships with fuel providers which offer them a discount over general fuel prices. In order to determine the lowest fuel price, however, the individuals or flight planning departments.(i.e., users) must access each fuel provider separately and query for fuel prices at each location (i.e., each designated airport). Because this process requires a separate login for each fuel provider and requires the user to manually gather and analyze the fuel price differentials, the process is time consuming, inefficient, and tedious.

Therefore, there is a need for a system and method for quickly and efficiently providing consolidated pricing information from a plurality of sources.

### BRIEF DESCRIPTION OF THE DRAWINGS

FIG. 1 is a block diagram of an environment in which embodiments of the present invention may be practiced;

FIG. 2 is a block diagram of an exemplary price consolidator;

FIG. 3 is a flowchart of a method for registering with the price consolidator;

FIG. 4 is a flowchart of a method for performing a price search; and

FIG. 5 is a sample search result, according to one embodiment of the present invention.

### DESCRIPTION OF EXEMPLARY EMBODIMENTS

The present invention provides systems and methods for efficiently providing consolidated pricing information from a plurality of sources. While the following description will discuss the system and method in terms of providing aircraft fuel pricing information, embodiments of the present invention may be utilized to provide pricing information for any item of interest.

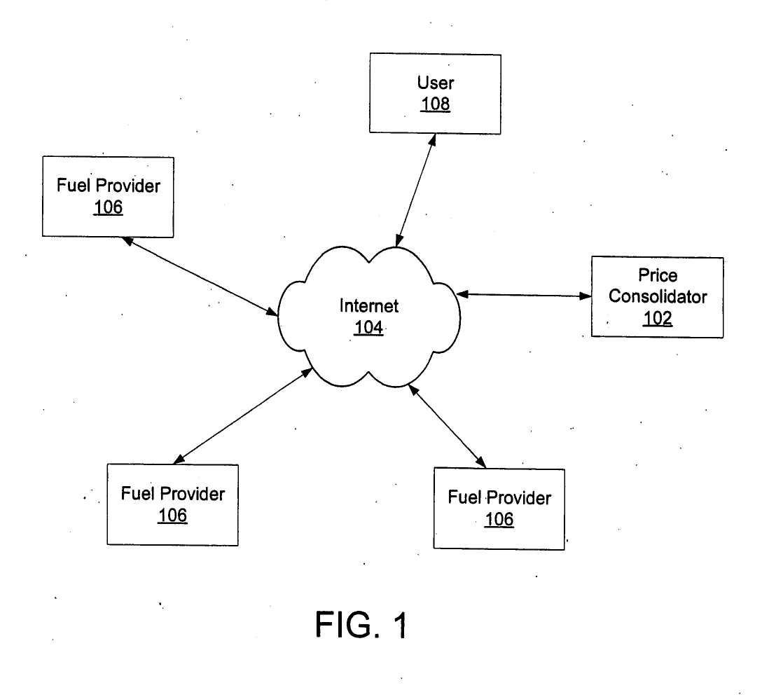

Referring to FIG. 1, an exemplary environment 100 in which embodiments of the present invention may be operated within is shown. The environment 100 may comprise a price consolidator 102 coupled via the Internet 104 to a plurality of fuel provides 106 and a user 108. Although only three fuel providers 106 and one user 108 are shown, any number of fuel providers 106 and users 108 may be coupled to the price consolidator 102 at any time, and any number of users 108 may search fuel prices at any one time.

The price consolidator 102 accesses the fuel providers 106 in order to obtain fuel price information requested by the user 108. The user 108 may be a pilot, a flight planning department, or any other entity which requires fuel price information. The fuel provider 106 may be discount and non-discount fuel providing businesses or services. Some discount fuel providers include AirBP, AVCard, AVFuel (Commercial Contract), AVFuel-Platinum Flight Card, Chevron Texaco, and Western Petroleum, among others. Fuel prices for various types of fuel may be obtained via embodiments of the present invention, including, but not limited to, Jet-A fuel and Avgas.

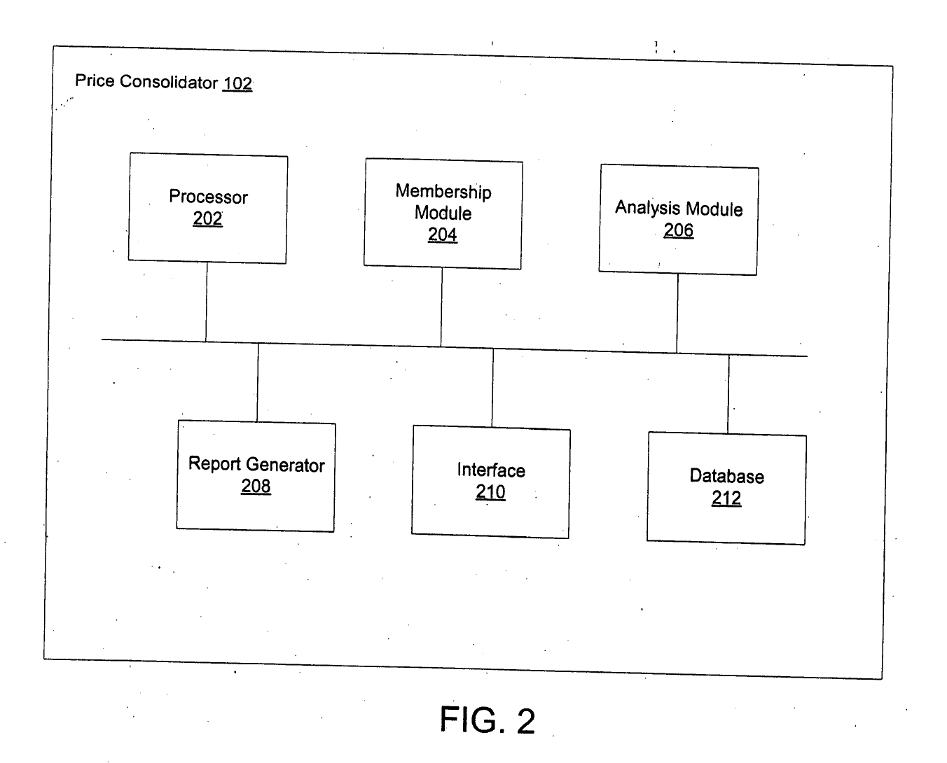

Referring now to FIG. 2, an exemplary price consolidator 102 is shown in more detail. The price consolidator 102 may comprise a processor 202, a membership module 204, an analysis module 206, a report generator 208, an interface 210, and a database 212.

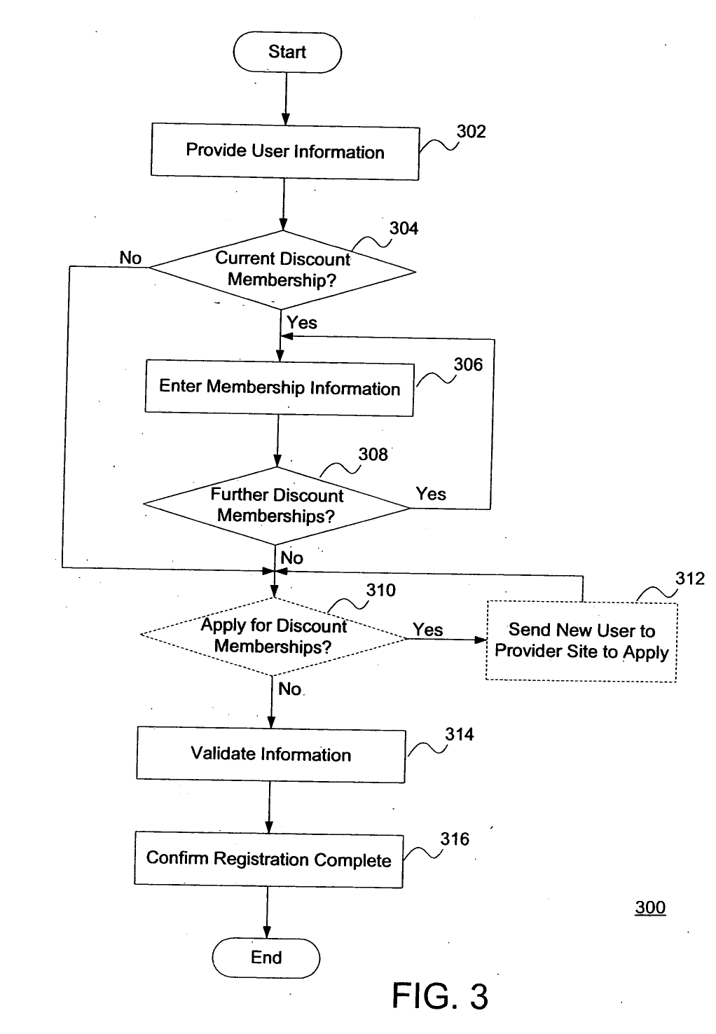

The exemplary membership module 204 processes initial registrations as well as member logins to the price consolidator 102. In exemplary embodiments, in order to utilize the price consolidator, the user 102 must register with the price consolidator 102. The registration process will be discussed in more detail in connection with FIG. 3 below. Once registered, the user's information is maintained in the database 212. If edits to the user's information is needed, the membership module 204 processes those edits and updates the database 212 accordingly.

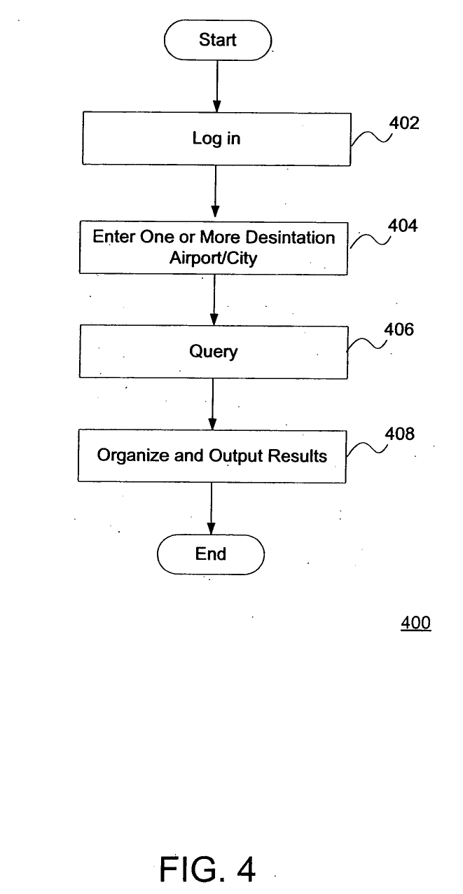

The analysis module 206 receives fuel pricing queries, processes the queries, and provides the query results to the user 102. In exemplary embodiments, the query includes fuel requirement and destination information. Based on this information, the analysis module 206 retrieves user membership information and accesses various fuel providers to obtain regular and discounted fuel prices. The results are then organized by the analysis module 206 and provided to the user 102. The process will be discussed in more details in connection with FIG. 4 below.

The report generator 208 generates various reports based on membership information and search queries. Reports may be generated for the users 102 as well as for the price consolidator 102 administrators. For example, the user 102 may obtain a transaction report including transaction history and cumulative total savings, a Jet-A and/or Avgas discount report which displays current discount programs the user subscribes to, and a “current” average fuel price by region report. This last report may be accessed by member and non-member users and may be updated daily or on any other basis. Additionally, the report generator 208 may generate a “best deal” report which includes the “current” lowest priced fuel providers in a specific region (e.g., national, state, local). Administrators may obtain daily transaction reports and multiple login reports, for example.

In a further embodiment, past prices retrieved from fuel providers 106 may be stored in the database 212 in order to create historical data reports. For example, reports may be generated which detail fuel prices for the last 30, 60, or 90 days in one or more regions (e.g., national, state, or local). These historical data reports may include average or lowest priced fuel data in a specific region over a selected time period. All reports generated by the report generator 208 may utilize current fuel prices, past fuel prices, or a combination of both.

The exemplary interface 210 is a communication interface that provides the price consolidator 102 access to the fuel providers 106 and users 108 (FIG. 1). That is, the price consolidator 102 obtains pricing information from fuel providers 106 via the interface 210. The price consolidator 102 also receives information and queries from the user 108 and provides information and results to the user 108 via the interface 210.

The database 212 stores membership and report data. In further embodiments, the database 212 may comprise more than one database 212 for storing information. For example, there may be a database 212 for storing membership information and a separate database 212 for storing reports. Additionally, the database 212 may be located external to the price consolidator 102 but coupled thereto.

It should be noted that alternative embodiments of the price consolidator may comprise more, less, or alternative elements. For example, a payment gateway processor may be provided to process payments and refunds. An associated payment database may also be provided to store credit card or other payment information.

Referring now to FIG. 3, a flowchart 300 of an exemplary method for registering with the price consolidator 102 (FIG. 2) is provided. In step 302, the new user provides information for registration to the membership module 204 (FIG. 2). The information may include user name, contact information (e.g., address, phone number, e-mail address), aircraft make/model and payment information (e.g., credit card, PayPal, etc.). The user may also select to establish an auto-renew option for their fuel consolidator membership.

Additionally, the user selects a membership plan with the price consolidator 102. In one embodiment, the membership plan (or subscription level) may be based on the size of the plane's tank of the user. For example, level 1 may comprise planes with 0-400 gallon tanks, level 2 may comprise planes with 401-999 gallon tanks, level 3 may comprise planes with 1000-2500 gallon tanks, and level 4 may comprise planes with 2501-5000 gallon tanks. Alternative embodiments may comprise other methods for determining membership plans. For example, a user 108 (FIG. 1) who signs up for a multi-year plan may be given a discount membership rate over a user 108 that only signs up for a single year. In a further example, a user 108 with multiple membership plans (e.g., user 108 owns different tank-sized planes) may receive a discount over a user 108 with only one membership plan.

In step 304, if the new user currently has membership with discount fuel providers, then the information is entered in step 306. In one embodiment, a menu of available discount fuel providers is provide with fields for the user to enter their user name and password for each discount fuel provider. Alternatively, the user may select all the discount fuel providers they are members of, and subsequent menus/screens will allow the user to enter discount fuel provider membership information (e.g., user name and password) for each discount fuel provider (step 308).

If the new user is not a member of any discount fuel provider programs or would like to join more discount fuel provider programs, the membership module 204 provides an option for the new user to apply in optional step 310. In one embodiment, the user is sent to the discount fuel provider website (optional step 312) where the user can apply for membership directly with the discount fuel provider 106 (FIG. 1). In an alternative embodiment, the new user may enter application information for the discount fuel provider programs they would like to join, and, using the same payment information for registering with the price consolidator 102 the membership module 204 accesses each discount fuel provider 106 and obtains membership for the new user.

In step 314, the user information is validated. For example, if there are any problems with registering with price consolidator 102 (e.g., user name not available), the membership module 204 notifies the user and requests the problem be resolved (e.g., select new user name). Alternatively, if the user name and password combination given for a particular discount fuel provider 106 is invalid, the new user is requested to reenter the information. The membership module may also verify the new user's e-mail address and payment information.

Once validated, the new user registration is completed (step 316). In various embodiments, the new user is shown a registration complete message or is automatically sent to a login page. In a further embodiment, a confirmation e-mail may be sent to the new user's confirmed e-mail address.

Once registered, the user 108 (FIG. 1) may access and query for fuel prices via the price consolidator 102 (FIG. 2) at any time. FIG. 4 shows a flowchart 400 of an exemplary method for querying fuel prices. In step 402, the user 108 logs in with the price consolidator 102. According to one embodiment, the user 108 provides their price consolidator user name and password to log in. With the single log in with the price consolidator 102, the user may access all discount fuel providers of which they are members, and receive both discount and non-discount fuel pricing all from one source.

Once logged into the price consolidator, the user 108 may enter one or more destination airport/city in step 404. In one embodiment, the user enters one or more destinations (including alternative nearby airports) in which they are interested in obtaining fuel pricing. For example, if the user is flying into San Jose, Calif., the user may check for fuel pricing at San Jose International (SJC), by entering this destination. In an alternative embodiment, the user 108 may enter their destination airport (e.g., SJC) and the analysis module 206 (FIG. 2) determines alternative nearby airports to check (e.g., Palo Alto and Reed-Hillview) for fuel pricing. The alternative airport information may be stored in the database 212 (FIG. 2).

In yet a further embodiment, the user 108 is able to generate a flight route fuel plan by entering a start and final destination. The analysis module 206 may allow the user 108 to select from a flight route with the lowest fuel prices or shortest flight distance, or a flight route of the user's 108 own choosing. With this last option, the user 108 may enter multiple intermediate destinations for refueling, or the analysis module 206 may provide a list of these intermediate destinations from which the user 108 may select. Frequently used flight plans, may be stored in the database 212 and associated with the user 108. The user 108 then is able to recall these flight plans at a later time.

In step 406, the analysis module 206 performs a fuel pricing query. The analysis module 206 first determines which discount fuel provider programs the user 108 is a member of, and retrieves the discount fuel provider 106 (FIG. 1) program login information from the database 212 (FIG. 2). The analysis module 206 then accesses the fuel providers 106 to determine fuel prices at the requested destination airport(s)/city(ies).

Once fuel pricing is obtained for all the fuel providers 106 in all the destination airports/cities, the information is consolidated in step 408. In exemplary embodiments, the fuel pricing information is organized into a matrix and provided to the requesting user 108. Alternative embodiments may comprise additional or fewer steps.

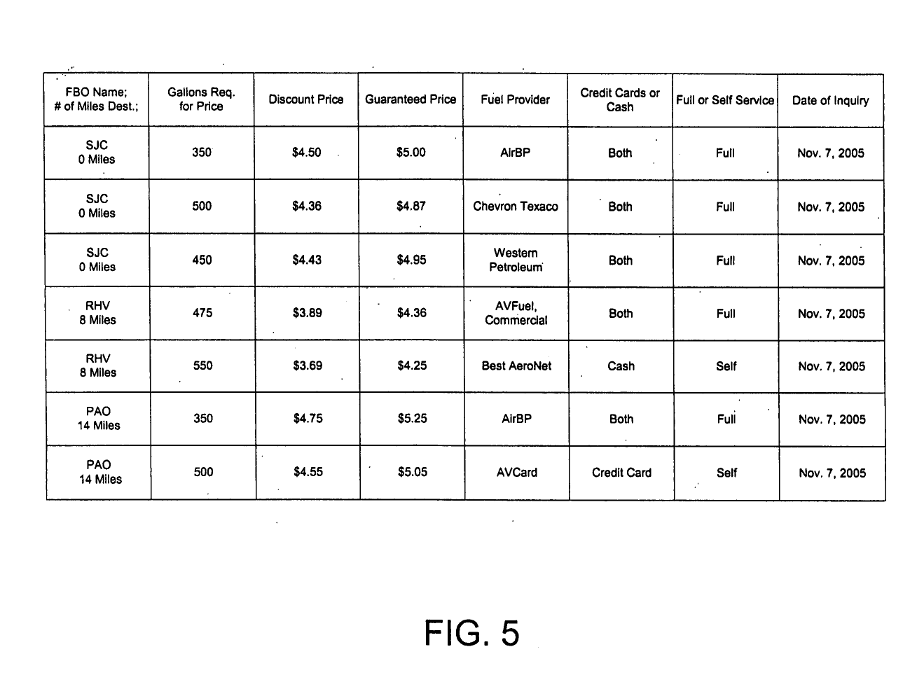

FIG. 5 illustrates an example fuel price search result. In the exemplary embodiment, the result is provided in a matrix format. In this example, the user 108 (FIG. 1) queried for fuel prices in the San Jose, Calif. region. The query includes destination airport San Jose International (SJC) and nearby airports Reed-Hillview (RHV) and Palo Alto (PAO). The discount price is the price the user 108 pays as a member of the associated discount fuel provider program while the “guaranteed” price is the current price available to the general public. While the results are sorted via distance from destination airport and via discount fuel provider name, further embodiments may allow selectable sort options. For example, the user 108 may sort by price or fuel provider name. Additionally, the lowest price option may be presented in highlight or graphically indicated in some manner.

Alternative embodiments may present the results in a different manner. For example, only the lowest priced three or five options (e.g., number of options may be determined by the user 108) may be presented to the user 108. Further embodiments also may not utilize all the columns of information shown in FIG. 5. The user 108 may be able to set up user preferences to obtain the results in any manner they desire. These user preferences are then stored in the database 212 (FIG. 2). In a further embodiment, the results of the query may be sent to a portable device, e-mailed, printed, etc.

It should be noted that the search results may include both discounted and non-discounted fuel pricing information. For example, one destination may have a non-discount fuel provider or a discount fuel provider which the user is not a member with that has lower priced fuel than other fuel providers. Thus the search results will include this non-discounted fuel price information.

The present invention is described above with reference to exemplary embodiments. It will be apparent to those skilled in the art that various modifications may be made and other embodiments can be used without departing from the broader scope of the present invention. For example, a process similar to that described above may be utilized to obtain automobile fuel pricing for trucking and ground delivery industry. Therefore, these and other variations upon the exemplary embodiments are intended to be covered by the present invention.

What is claimed is:

1. A method for obtaining consolidated fuel pricing information comprising:
receiving at least one destination or flight route from a user;
obtaining nearly real-time fuel pricing information from each fuel provider at each of at least one destination; and
organizing the fuel pricing information into a single source for the user.

2. The method of claim 1 further comprising obtaining user discount and regular fuel provider information from a database or information source and utilizing the user discount and regular fuel provider information to access each discount and regular fuel provider's fuel pricing information.

3. A method for quick and easy ways to locate the best fuel prices available—solving a time consuming problem of searching multiple contract fuel sites and other data sources for best available current pricing thereby providing a single source alternative.
